(19) United States
(12) Patent Application Publication
(10) Pub. No.: US 2007/0164103 A1
(43) Pub. Date: Jul. 19, 2007

(54) Digital identification

(76) Inventors: Jeffrey Berkowitz, Monsey, NY (US); Mark Karsch, West Nyack, NY (US)

Correspondence Address: KALIKO & YEAGER, L.L.C., 500 NORTH FRANKLIN TURNPIKE, RAMSEY, NJ, 07446, US

(21) Appl. No.: 11/654,233

(22) Filed: Jan. 17, 2007

Related U.S. Application Data
(60) Provisional application No. 60/759,466, filed on Jan. 17, 2006.

(51) Int. Cl. G06K 5/00

(52) U.S. Cl. 235/380

(57) ABSTRACT

Devices, systems, and methods for providing an identification card are disclosed. The exemplary method may transmit an electronic copy of the user's identification documentation to be verified at a verification station. The original identification documentation may be authenticated and compared at a distribution location. Another exemplary embodiment of the invention may provide a user with an immediate identification card at a kiosk. All of this information may be collected and transmitted to a central storage location where it may be readily accessible if needed. An identification card containing all the information may be distributed to the user at the kiosk and/or a CD or other memory storage devices with the user's electronic information.

### CROSS REFERENCE TO RELATED APPLICATIONS

This application claims priority to U.S. Provisional Patent Application No. 60/759,466 filed Jan. 17, 2006 entitled “Digital Identification”, which is incorporated fully herein by reference.

### FIELD OF THE INVENTION

The present invention relates generally to digital identification systems, and more particularly to a system for acquiring identification information.

### BACKGROUND OF THE INVENTION

In the United States, driver's licenses are issued by the states, not by the federal government. States also issue identification cards for non-drivers. Up until now the States set the rules for what data is on the card and what documents must be provided in order to obtain one. States also maintain their own databases of licensed drivers and ID-card holders. Because of recent legislation, a Federal agency may not accept, for any official purpose, a driver's license or identification card issued by a State unless the State is meeting certain requirements specified in the legislation. According to this legislation, a person may need a federally approved license or ID card to travel on an airplane, open a bank account, collect Social Security payments, or take advantage of nearly any government service. In the legislation, the Department of Homeland Security has been given the authority to set the standards for the federally approved license or ID card. Requirements such as a fingerprint or a retinal scan may be permitted. Much of the information and documentation from each individual who wishes to receive a federally approved license is required to be verified, digitized, and stored permanently.

The new standards require major changes to state systems applications and the management of information relating to standardized identification systems across jurisdictions. Due to the volume of licenses that would need to be issued and the additional information, verification, and storage requirements, state agencies will require innovative methods and systems to handle federally approved licenses. The monetary impact on the state agencies is sizeable. This impact is likely to be felt from any individual who pays taxes, as well as, any individual who will have to pay for a federally approved license.

In another application, hundreds of thousands of children are reported missing in the United States every year. Despite the passage of many laws attempting to address this issue, the problem continues to grow. By law, all children, regardless of the reason they are missing, must be entered immediately into State and Federal computer networks. The minimum information that is required to be entered immediately includes: (A) the name, date of birth, sex, race, height, weight, and eye and hair color of the child; (B) the date and location of the last known contact with the child; and (C) the category under which the child's reported missing. The information is put in to the state law-enforcement system and the National Crime Information computer networks and made available to the Missing Children clearinghouse within the state or other agencies designated within the state to receive such reports.

It is imperative that as soon as a child is thought to be missing that quick action is taken. The FBI maintains that the first three hours of a missing child are the most crucial, and precious time is lost when the parent needs to travel back home in a frantic search for the most recent “school portrait” quality photograph of their child. The Justice Department recommends that parents keep up-to-date photographs of their children in a digital format and readily available. In the event of a missing child, the child's digitized information can be immediately sent in the acceptable format to the National Crime Information Center, as well as the National Center for Missing and Exploited Child's database, and be broadcast to law enforcement agencies. Posters of the child can be produced and distributed to news organizations and retail stores for posting. The FBI and NCMEC also recommend that each child be fingerprinted. Fingerprints have served all governments worldwide during the past 100 years to provide accurate identification of individuals. No two individual's fingerprints have ever been found alike. The problem is in the available labor, time, and cost involved in fingerprinting the millions of children in our nation.

There are also a large number of children who run away from home each year. Assaults, illness, or suicide takes the lives of thousands of runaway youth each year. Early fingerprinting of children may help reunite some of these children with their parents. Often, runaway children are forced to turn to crime to continue their flight due to the lack of funds. If caught and fingerprinted, the runaway child could be identified as a missing child and reunited with their parents. Many states currently require fingerprints in the driver's licensing process. This would again allow for more runaway children to be identified and reunited with their parents.

Beginning Jan. 23, 2007, all persons, including United States citizens, traveling by air between the United States and Canada, Mexico, Central and South America, the Caribbean, and Bermuda will be required to present a valid passport. There are several restrictions on photographs that may be used to obtain a passport. An efficient method for obtaining passport photographs is also desirable.

Accordingly, an efficient and effective system and method is needed for providing an identification card containing electronically stored personal information, biometrics, and a photograph. The method and system should also allow for an efficient and convenient verification process of the user information stored electronically on the card. And further, the method and system should transmit the recorded information to an appropriate location (i.e. to a verification station for information to be verified or to a police database to be immediately accessible in the event of a missing person).

### SUMMARY OF THE INVENTION

It is, therefore, an objective of the present invention to provide devices, systems, and methods for providing an identification card. An exemplary embodiment of the invention may create and transmit an electronic file from a user kiosk to a verification station for verification. The original identification documentation may then be authenticated and compared for validity at a distribution location. Once this is accomplished, the identification card or license may be distributed to the user.

In another exemplary embodiment of the invention, an unattended kiosk may be used for providing an identification card. The system may be initiated with a user's visit to the kiosk. At the kiosk, personal data may be input by the user, an electronic image of the user may be created, and biometrics of the user may be recorded electronically. The collected information may be transmitted to a central data storage center where it may be readily accessible if needed. An identification card containing all the information may be distributed at the kiosk to the user.

### BRIEF DESCRIPTION OF THE DRAWINGS

The above and other objectives and advantages of the present invention will be apparent upon consideration of the following detailed description, taken in conjunction with the accompanying drawings, in which like reference numbers refer to like parts throughout, and in which:

FIG. 1 is a generalized schematic of an exterior of an exemplary embodiment of a kiosk.

FIG. 2 is a generalized schematic of a an interior of an exemplary embodiment of a kiosk.

FIG. 3 is a flow chart illustrating an exemplary method for obtaining a verified identification card by initially providing information at a kiosk.

FIG. 4 is a flow chart illustrating an exemplary method for obtaining an identification card from a kiosk.

FIG. 5 is a generalized schematic of an exemplary method used to provide a verified identification card.

### DETAILED DESCRIPTION

The invention disclosed herein includes a stationary or mobile identification kiosk. The purpose of such a kiosk is to record personal biometrics and personal identification data of individuals or users. This data may include personal biometrics for measuring and analyzing human body characteristics such as fingerprints, eye retinas and irises, voice patterns, facial patterns, hand measurements, DNA samples/mapping, or any other suitable data that may be used to identify an individual. The personal identification data may include, for example but not limited to, the full legal name, nickname, date of birth, address, signature, height, weight, sex, age, eye color, identifying marks, glasses, braces, doctor contact information, or any other suitable data that may be used to identify a person. Some or all of this data may be provided to users in an electronic format (e.g., CD, portable memory storage card, or any other suitable device) and/or in a hard copy. Some or all of the data may be transmitted to a remote server for storage or may be transmitted to personal remote devices (e.g., PDA's or any other suitable device) via a Bluetooth™, a cellular, or any other suitable wired or wireless connection. The data may be stored in a format that comports with local, state, or federal databases for the purpose of easy integration into such systems.

The invention may further include a link into the national “Amber Alert” system. The Amber Alert system is a notification system to the general public, by various media outlets, that a confirmed abduction of a child has happened. The invention may allow for a missing person's identification information to be disseminated within minutes and may dramatically speed the safe recovery of the missing person. The invention set forth herein may further include a visual display system to display information related to a recent abduction. The invention may also include a means to contact local authorities in the event that a missing child is located.

In order to input the biometrics data and other data provided for herein, the invention may include: a keyboard, a microphone, speech to text software, a retina scanner, a fingerprint scanner, a camera, a mouse, a memory storage device reader, or any other suitable device designed to collect the biometrics data and other data provided for herein. The invention may also include a printer, a CD ROM recorder, a wire or wireless connection to the Internet, or any other suitable device to provide output of data to a local or remote location. A CD distributed to the user may allow the user to distribute a dependent child's (or dependent adult's) identification information to family members or care-givers. The invention may also provide a card with the photograph, signature, fingerprints of the individual, and/or barcode with additional information. The invention set forth herein may further include a notification to the individual at the kiosk if for any reason the verification system determines that the submitted documents are not sufficient.

The invention may also include a visual display system to display information related to an Amber Alert. Such a system may include a visual display screen to display pictorial and other information related to an abducted person. The system may also include an audio or visual indication that an abduction has recently taken place (e.g., a flashing light, a siren, or any other suitable audio or visual indicator).

The invention may also include a payment device to accept payment for services including a cash, credit cards, gift cards, pre-paid card, or any other suitable means to accept payment. The invention may also include a dispensing means to dispense printouts of the data set forth herein, electronic copies of the data set forth herein, and/or DNA kits. The invention set forth herein may include a means to create a wireless web account that allows users to modify data that is remotely stored from any remote device with an Internet connection. The remotely stored data may be accessed quickly and disseminated almost immediately if the individual is reported missing. The invention may also include a camera that utilizes user-friendly software to capture several digital images of the user. The user may then choose the best image to have stored on the identification card.

The invention set forth herein may include a bar code scanner, a magnetic card reader, or another suitable device that may be used to scan or enter promotional or other suitable materials in order to provide discounts to users. This scanner or reader may also be used to scan previously issued identification cards to reduce user time involved in re-entering any unchanged data or other cards. Discounts may also be applied this way to “repeat” users. The invention set forth herein may include a memory storage device reader (e.g., CD ROM, memory card, etc.) that may be used to read memory storage devices associated with such readers. The storage devices may have information imbedded or stored on them to recognize former or new users and such information may be used to provide discounts to such users or to save the user time involved in re-entering any unchanged data. The invention may also include a processor to run user-friendly software that may guide the user through various transactions provided by the kiosk.

The invention may include distributing an identification card for employees who work around children to reduce the threat of child predators. The invention may include distributing identification cards for safety purposes to parents for their children, to senior citizens who may occasionally become disoriented, or to any dependent adults. The invention set forth herein may include a feature to allow an individual to print one or more photos acceptable for use in the process for obtaining a passport. The invention may be located in shopping malls, schools, churches, at festivals, retail outlets, airports or other convenient locations.

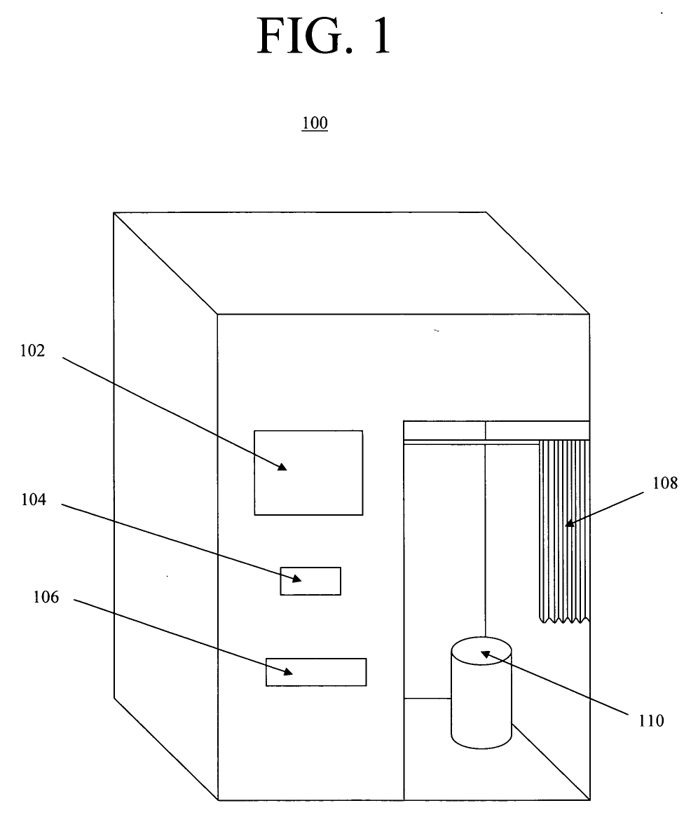

Referring to FIG. 1, the exterior view of an exemplary embodiment of a kiosk 100 is represented. The present invention may be a stationary kiosk in a fixed location or it may be a mobile kiosk that could be utilized in many different locations. In either case, the kiosk 100 may be unattended and may be available for the user at the user's convenience. An embodiment may include an exterior visual display system 102 for displaying crucial information relating to any recently issued Amber Alerts or other widely used systems to notify the public of a missing person alert. The visual display system 102 may also serve to display other visual information that may be of interest to the customer, such as instructions on the use of the kiosk or other pertinent child or user safety information. Additionally, an exemplary embodiment of the kiosk 100 may contain a payment device 104 that would accept various acceptable forms of payment from the user including cash, credit, gift cards, or other suitable methods of payment. Another embodiment of the present invention may also have an exterior distribution site 106. The exterior distribution site may dispense various items to the user including an identification card(s), print-outs or electronic copies of any information relating to the user's data, follow-up instructions for the user, DNA kits, or other information intended to be distributed to the user. An entrance to the kiosk 100 may contain a privacy curtain 108 allowing the user some degree of privacy from the external environment surrounding the kiosk 100. For the comfort of the user, a preferred embodiment of the present invention may include an adjustable seat 110 inside the kiosk 100. Once a user has stepped inside the kiosk 100, the user may close the privacy curtain 108 and sit down on the seat 110 in order to continue comfortably with the identification card process.

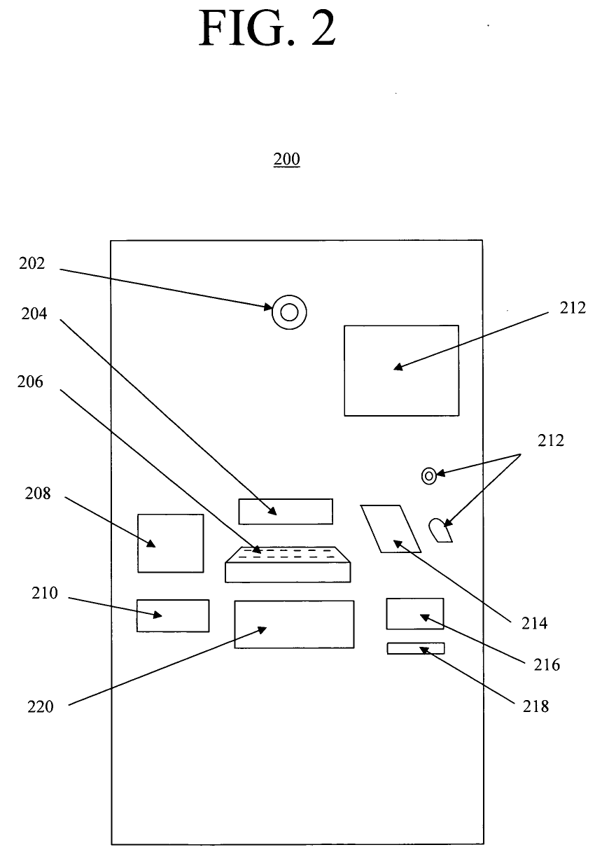

Referring to FIG. 2, an exemplary embodiment of an interior view of the kiosk 200 is represented. One exemplary embodiment of the present invention is described using kiosk 100 as the exterior view and kiosk 200 as the interior view of the embodiment. A camera 202 may be located on the interior of the kiosk to create an electronic image of the user. The image may also be contained in an electronic packet or folder of information that may be transmitted by the transmitter 204 through a wired or wireless connection to a local and/or remote location for storage and to enable immediate access at a later date. The remote location may include a police database or a state or federal database. The information may be stored in a format consistent with the database in which it is to be stored and later accessed. The electronic information packet may be immediately accessed by authorities in the event that the user is later reported missing or abducted. The digital information may then be quickly disseminated to the other law enforcement agencies, departments, voluntary organizations, news organizations, or other relevant organizations. Since the first three hours after a child goes missing or is abducted are most crucial, the ability to immediately access and widely disseminate this electronic information packet may prove to be lifesaving to the child or person.

The personal data to be input by the user may include the name, date of birth, sex, race, height, weight, eye and hair color, and any other information that might identify the individual. The information collected is not limited to this list and may include various other identifying traits. An exemplary embodiment of the present invention may include a data input device 206 for the user to input any personal data. The data input device 206 may be a keyboard, keypad, touch screen, and/or mouse, or other device suitable for entering data. A processor 220 may be used to run user-friendly software that may guide the user through various identification card options or photograph printing options. The options may include, but are not limited to, submitting information for federally approved identification cards, producing child identification cards and files, producing senior citizen or dependent adult identification cards, printing/developing of passport quality photographs, or printing/developing of entertainment photos.

An identification card may contain various biometrics data that may be useful later in identifying an individual. An exemplary embodiment of the present invention may include various biometrics scanners 212 intended to produce electronic files containing biometrics specific to an individual. The biometrics scanners may include a retina scanner, a fingertip/print scanner, a microphone for voice recording, speech to text software, or any other suitable device designed to collect biometrics.

Continuing to refer to FIG. 2, a exemplary embodiment of the present invention may include a document scanner 214, a bar code scanner 216, and a memory storage device reader 218. The document scanner 214 may allow the user to scan any documents that may be required or it may allow the user to provide any additional material desired on an identification card. The document scanner 214 may also have the capability of accepting user payments by personal check. A bar code scanner 216 may be used to allow the user to scan promotional materials. Another embodiment of the present invention may include a magnetic card reader either in addition to or in place of a bar code scanner 216. The magnetic card reader may allow the user to scan previously printed identification cards. For example, the magnetic card reader may be used to enter information from a prior issued license. The feature may allow the user to enter the requested information. Another feature may include the exterior payment device 104. A memory storage device reader 218 may be a panel containing various widely used memory storage device readers, such as a CD ROM, ports for memory cards, or USB connectors for memory sticks or other devices. This may allow the user to transmit information they have contained on a memory storage device into the electronic user packet or file of information for the identification card. The electronic information gathered via this medium may vary widely and may contain anything from critical health information to previously saved data.

The interior of an exemplary kiosk may contain an interior visual display device 212, a printing device 208, and an interior distribution site 210. The interior visual display device may also post Amber Alert information in addition to other relevant current transaction information. For example, a document preview may be useful to preview the identification card prior to distribution or to proof any of the information provided during the transaction. Instructions for the identification card process or follow-up instructions or procedures may be displayed on the interior visual display system 212. The printing device 208 may be used to provide the user with a hard copy of any information or files (including the identification card) that are intended to be distributed to the user. The interior distribution site 210 allows for identification cards, printed documents, DNA kits, or other materials to be distributed to the user.

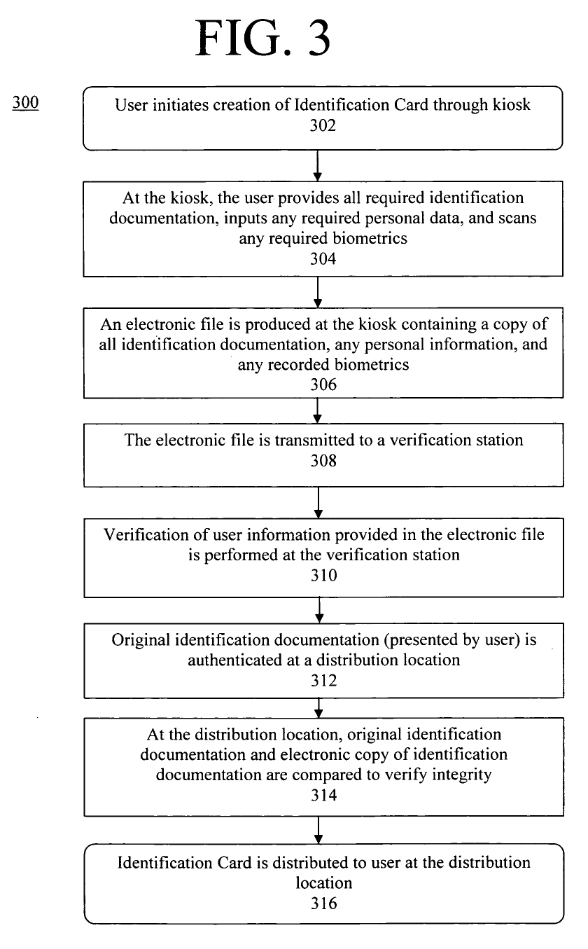

Referring to FIG. 3, an exemplary method for providing an identification card to a user partially aided by the use of a kiosk is described in a flowchart 300. In a circumstance where some or all of the information provided by the user must be verified by trained personnel prior to a card distribution, an exemplary embodiment of the present invention may be used to decrease the total time involved in the production and distribution of the identification card. The process of obtaining an identification card may be initiated when a user makes a visit to an identification card kiosk and begins a transaction (block 302). At the kiosk, the user provides any required identification documentation, inputs any required personal information, and records any required biometrics information (block 304). This may be accomplished by have the user swiping a previously issued license. The information may be entered into the required fields based on the previously issued license. The user may use the document scanner 214 in the kiosk to make electronic copies of any hard copy identification documents. The memory storage device reader 218 may be used to make electronic copies of any documentation the user provides in an electronic form, e.g. a memory stick, memory card, CD ROM, or other suitable memory storage device. The user may input his signature and/or the required personal data with the data input device 206. Any required biometrics may be recorded by using the biometrics scanners 212 located in the kiosk. When all of the required information has been provided as described above, a completed electronic file or packet is produced (at the kiosk) containing a copy of all the identification documents, any personal information, and any recorded biometrics (block 306). When the electronic file or packet is completed, the transmitter 204 transmits the electronic file to a verification station (block 308). At this point, the user may receive a date produced from the kiosk for the user to pick up the identification card from the distribution location. (This date allows sufficient time for the verification process which follows.) Another exemplary embodiment may provide the user with a date of card distribution through a later correspondence (not from the kiosk), e.g. via email, phone, or mail service. The user receives a card with his photograph, (maybe fingerprints), bar code and signature that the user may then be required to bring to the distribution or other station that verifies the user. At the station the clerk scans the barcode or fingerprint and his file is immediately retrieved. The clerk easily authenticates that the person is who the documents say he is with the match of signature or one or more biometric identifiers or visual comparison of identification information. This may complete the user's interaction with the kiosk (although the process of obtaining an identification card is not yet complete).

After the electronic file is received at the verification station, the user information contained in the electronic file is verified by qualified personnel at the verification station (block 310). This may include, for example, authentication of identification document, Scial Security number, general history, criminal background check, medical records check, and/or financial records check. The user may present or may be required to present original identification documentation at the distribution location (block 312). Also at the distribution location, the original identification documentation and the transmitted and verified electronic copy of the identification documentation are compared (by qualified personnel) to verify the integrity of the documentation (block 314). The process may then be completed with the distribution of the identification card to the user at the distribution location (block 316). The verification location may be the same location as the distribution location or they may be at separate locations.

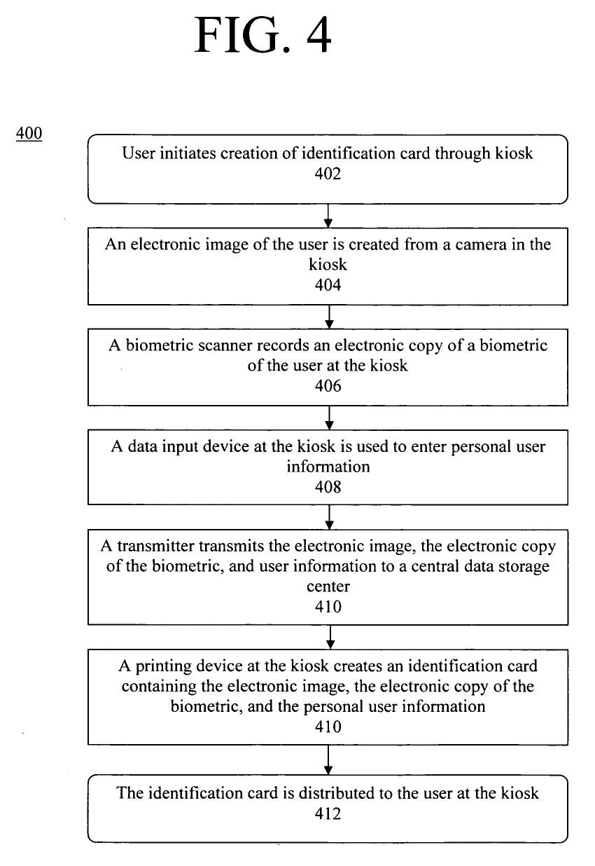

Referring to FIG. 4, another exemplary method for a user to obtain an identification card from a kiosk is described in a flowchart 400. The process is initiated when a user makes a visit to an identification card kiosk and begins a transaction (block 402). By using prompts on the visual display system 212 or posted instructions, the user has a photograph taken by the camera 202 in the kiosk to create an electronic image of the user (block 404). A biometrics scanner 212 records an electronic copy of the desired biometrics trait of the user (block 406). The data input device 206 is used to input the requested personal information (block 408). A transmitter 204 may transmit the completed electronic file (including the electronic image, the electronic copy of the biometrics, and the personal information) to a central data storage center (block 410). The data may now be immediately accessed in the event of a reported missing person. A printing device 208 at the kiosk creates an identification card containing the electronic image, the electronic copy of the biometrics, and the personal user information (block 412). The completed identification card is distributed to the user at the kiosk through the exterior or interior distribution site 210 and the process is completed (block 414).

Another embodiment of the invention may additionally distribute a CD or other memory storage devices to the user. The CD or other memory storage devices may contain all the electronic information contained on the identification card. The kiosk may also distribute multiple copies of the identification cards to the user. In another exemplary embodiment, the user may have the option of storing the completed electronic file (containing all of the information collected at the kiosk) in a private and secure database; instead of, or in addition to, the storage of the electronic file in the police, state, or federal databases as previously mentioned. The electronic file at the private and secure database may only be released to authorities with the express authorization of a parent or guardian.

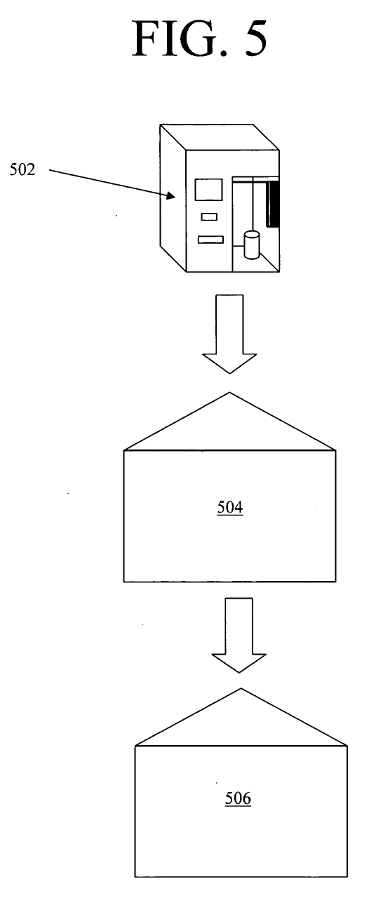

Referring to FIG. 5, an exemplary embodiment of a method 500 to provide a verified identification card is represented. The method begins with a user interaction at a kiosk 502. The user may provide all of the required documentation for an identification card at the kiosk 502. In the kiosk 502, the user has the resources to convert all of the documentation into an electronic form. Any additional biometrics may be electronically recorded in the kiosk 502. An electronic file may be constructed in the kiosk that contains all the required information and documentation. The electronic file may be transmitted wirelessly to a verification station 504. At the kiosk 502, the user may be given a date and location for the distribution of the identification card.

At the verification station, the electronic copy of the user's information may be verified by qualified personnel. The electronic file may then be transmitted to a distribution location 506. In this exemplary embodiment, the verification station 504 and the distribution location 506 are separate locations; however, the verification station 504 may be located within the distribution location 506. In any case, the user provides the original identification documentation at the distribution location 506 or some other form of identification process. Qualified personnel may authenticate the original identification documents and compare the original identification documents with the electronic copy created at the kiosk 502. The user may now receive a verified identification card.

It will be understood that the foregoing is only illustrative of the principles of the invention and that various modifications can be made by those skilled in the art without departing from the scope and spirit of the invention. Various aspects disclosed in the exemplary embodiments may be incorporated with aspects disclosed in other exemplary embodiments without departing from the scope of the invention.

The present invention can be practiced by other than the described embodiments, which are presented for purposes of illustration rather than of limitation and that the present invention is limited only by the claims that follow.

What is claimed is:

1. A method for providing an identification card, the method comprising the acts of:
producing an electronic copy of an identification document of a user at an unattended kiosk;
transmitting the electronic copy to a verification station;
verifying user information in the identification document based on the electronic copy;
authenticating the identification document;
comparing the identification document with the electronic copy; and
distributing the identification card to the user.

2. The method of claim 1, wherein two or more identification documents are provided by the user at the unattended kiosk.

3. The method of claim 1, wherein the action of producing an electronic copy further comprises:
capturing an electronic image of one or more of a group consisting of the user, the signature of the user, biometrics of the user, and personal data input from the user.

4. The method of claim 1, further comprising the act of:
notifying the user via the kiosk of a date and a location that the identification card is to be ready for distribution.

5. The method of claim 1, wherein the kiosk is a mobile identification kiosk.

6. The method of claim 1, further comprising the act of:
providing the user at the kiosk a user file copy of output containing the user information provided at the kiosk by the user.

7. The method of claim 1, wherein the electronic copy of the identification document is produced from a memory storage device provided by the user and read by a memory storage device reader at the kiosk.

8. A system for providing an identification card, the system comprising:
a user kiosk for producing an electronic copy of an identification document of a user;
a communication means for transmitting the electronic copy of the identification document from the user kiosk to a verification station;
the verification station to verify user information from the electronic copy of the identification document;
a distribution location for authenticating and comparing the identification document with the electronic copy, and distributing the identification card.

9. The system of claim 8, wherein the user kiosk produces an electronic copy of two or more identification documents provided by the user.

10. The system of claim 8, wherein the user kiosk produces an electronic copy capturing an electronic image of one or more of a group consisting of: the user, the signature of the user, biometrics of the user, and personal data input from the user.

11. The system of claim 8, wherein the user kiosk notifies the user of a date and a location that the identification card is to be ready for distribution.

12. The system of claim 8, wherein the user kiosk is a mobile identification kiosk.

13. The system of claim 8, wherein the user at the kiosk is provided with an user file copy of user information provided at the kiosk by the user.

14. The system of claim 8, wherein the user provides at the kiosk a memory storage device containing an electronic copy of the identification document, and the kiosk utilizes a memory storage device reader to read and copy the electronic file.

15. An unattended kiosk for providing an identification card, the system comprising:
a camera for recording an electronic image of a user;
a biometrics scanner for recording an electronic copy of biometrics of the user;
a data input device for entering user information;
a transmitter for transmitting the electronic image, the electronic copy of the biometrics, and user information to a central data storage center; and
a distribution device for providing an identification card storing the electronic image, the electronic copy of the biometrics, and the personal user information to be dispensed to the user at the kiosk.

16. The system of claim 15, further comprising”
a dispensing site that allows for the distribution of additional materials to the user.

17. The system of claim 15, further comprising:
a memory storage device reader for reading electronic files from a user supplied memory storage device.

18. The system of claim 15, further comprising:
a visual display system to display current information related to an Amber Alert.

19. The system of claim 15, further comprising:
a payment means to accept payment for services.

20. The system of claim 15, further comprising:
a deposit site that allows for the deposit of physical identification materials associated with the user.
